(19) United States
(12) Patent Application Publication
(10) Pub. No.: US 2005/0234886 A1
(43) Pub. Date: Oct. 20, 2005

(54) Report designer tool and method

(76) Inventors: Karim Mohraz, Wiesloch (DE); Kai Wachter, Dossenheim (DE)

Correspondence Address: FISH & RICHARDSON, P.C., PO BOX 1022, MINNEAPOLIS, MN, 55440-1022, US

(21) Appl. No.: 10/929,128

(22) Filed: Aug. 27, 2004

Related U.S. Application Data
(60) Provisional application No. 60/562,731, filed on Apr. 16, 2004.

(51) Int. Cl. G06F 17/30

(52) U.S. Cl. 707/3

(57) ABSTRACT

A computer-implemented method for generating a report of a business warehouse system query includes identifying one or more row types of the query and defining a template for each row type. The method also includes applying the template to query data according to the row type to generate a formatted report. The template defines a format and a pattern for the row type.

### CROSS-REFERENCE OF RELATED APPLICATIONS

This application claims priority of U.S. provisional application Ser. No. 60/562,731, filed Apr. 16, 2004.

### BACKGROUND

In conventional business warehouse (BW) systems, reports generated based on a query of a business warehouse database are rendered according to a standard that is usually inflexible and difficult to use. An example of a report is a table of columns and rows, where the intersection of one column and one row defines a cell that includes one object of data from the query. The format of such tables is usually predefined: i.e. lines are one color, text is another color, and the background of the cells is yet another color. Changes to such a format usually can only be made globally for the report.

A table report can be provided as a spreadsheet, such as an Excel spreadsheet for example. The format of a spreadsheet table is typically programmed for each report, thus the entire formatting is easy to lose, and must be reprogrammed for each report generated. Users can only influence formatting such as colors, font size, or font type by tools such as a Web Template Stylesheet. Web-based report layouts can typically only be changed via a table interface or XML item, which requires ABAP or Javascript programming skills.

### SUMMARY

In one implementation, the present disclosure relates to a computer-implemented method for generating a report of a business warehouse system query. The method includes identifying one or more row types of the query, defining a template for each row type, and applying the template to query data according to the row type to generate a formatted report. The template defines a format and a pattern for the row type.

The pattern may include any type of color, text type, font type, and/or outline. For example, the pattern may be a grid-based pattern. The method may also identify one or more structural elements of the query, such as a dimension, a structure, and a hierarchy. The method may also include identifying combinations of structural elements, such as a dimension x dimension and/or a hierarchy x structure x dimension, and extracting data from the query. The method may also include associating the structural elements of the query with the template, generating the formatted report according to the template, rendering the formatted report in a display, and exporting the formatted report.

In another aspect, described is a system for generating a report of a business warehouse system query that involves a database to store business warehouse data, and a report designer program, responsive to user input from an input device, to configure a template of a report based on one or more row types in the query. The system includes a display coupled to the report designer program that is operable to display a report formatted according to the template.

The report designer program can be configured to be delivered from a website and/or stored on a client computer. The report designer program can be used with a graphical user interface to generate one or more reports. The template can be configured to define user-selectable formatting and layout of the report based on one or more rows. The report designer program can also be configured to define rules for one or more data objects in the report, and include one or more “drag and drop” functions for one or more formats to be applied to the template. The “drag and drop” functions can include a property box to select properties of a report rendering, and a format box to represent one or more formatting objects to be applied to individual cells or rows of the report. The report designer program may also use XML code to represent a report template encoding scheme for rendering the report.

In another implementation, described is computer program product, stored on a machine-readable medium with instructions operable to cause data processing apparatus to design a report of a business warehouse query that involves identifying a row type for a row or a row group in the report, defining a row pattern template for each row type, and identifying one or more structural elements of the query. The structural elements include a dimension, a structure, and a hierarchy. Instructions are also included to associate a structural template for each of the structural elements, and render a report associated with the query according to one or more templates. The one or more templates include the row pattern template and/or the structural template.

The design of the report may involve exporting the rendered report. The row pattern template may be defined at runtime, and the report can be designed based on the row type.

The systems and techniques described here may provide one or more of the following advantages. For example, a user can use a report designer program to design page headers, report headers, and insert custom text within the business warehouse data cell for a business warehouse report. Designs can be conducted on row patterns and a metadata-level of the queries. Formats can be defined for each report cell, as well as for structures and hierarchies. Rules can be defined for characteristic values in the report, and a layout for the business warehouse report can be dynamically arranged. Web-based report layouts can be designed without a knowledge of programming skills.

The details of one or more implementations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A-D are examples of a report.

FIG. 2 is a flowchart of a report design process.

FIG. 3 is a block diagram of a report designer system.

FIG. 4 shows a screen shot of an exemplary report designer tool.

FIG. 5 illustrates an association between a report template and a resulting report.

FIG. 6 illustrates group levels and corresponding query structural elements.

FIG. 7 is XML code including <bind> tags and data context.

Like reference symbols in the various drawings indicate like elements.

### DETAILED DESCRIPTION

This document discloses a report design system and method for use in a business warehouse or collaborative enterprise environment. The system and method enable a user to dynamically format and configure a layout of a report of a business warehouse (BW) query.

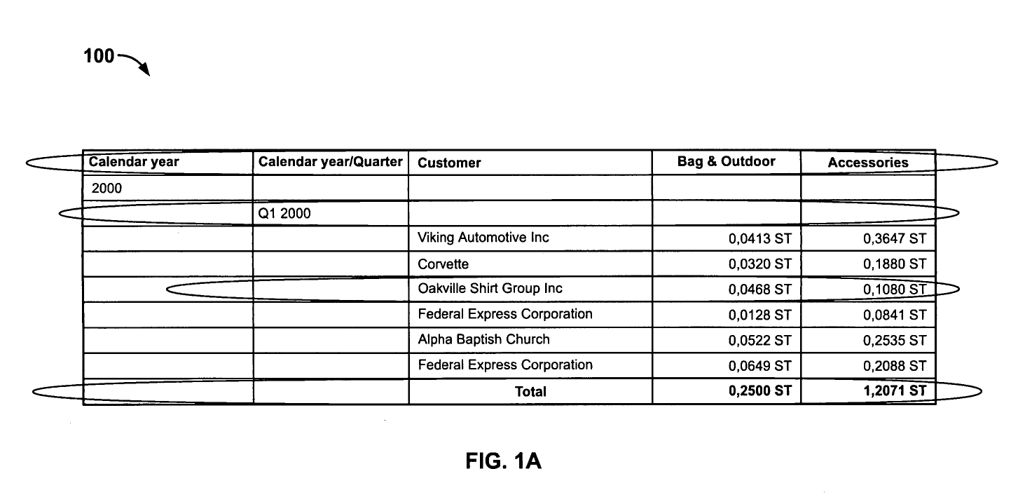

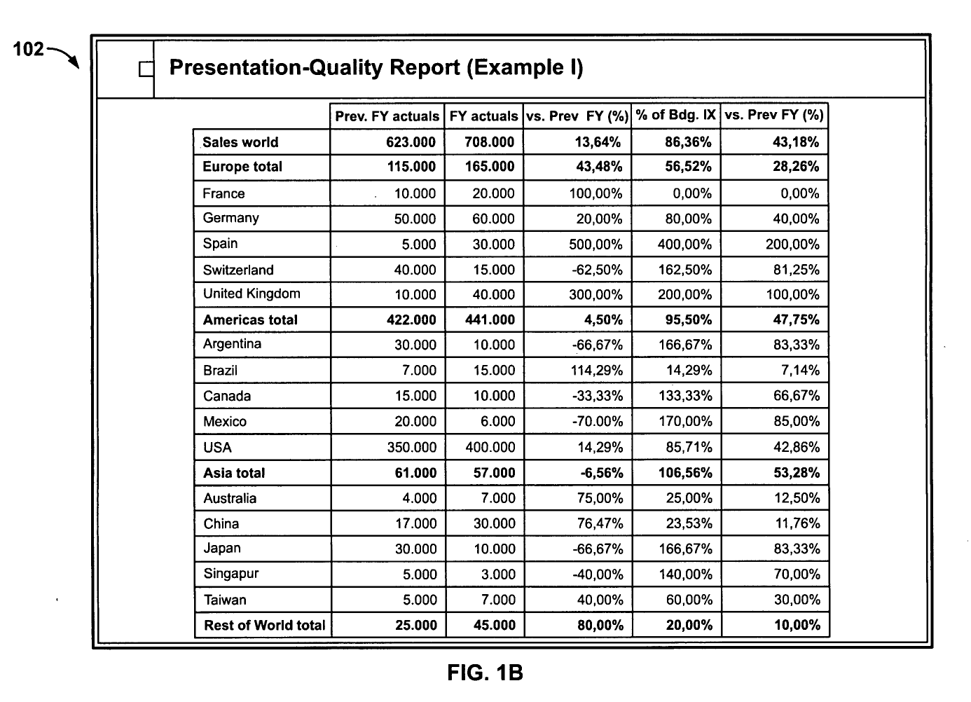

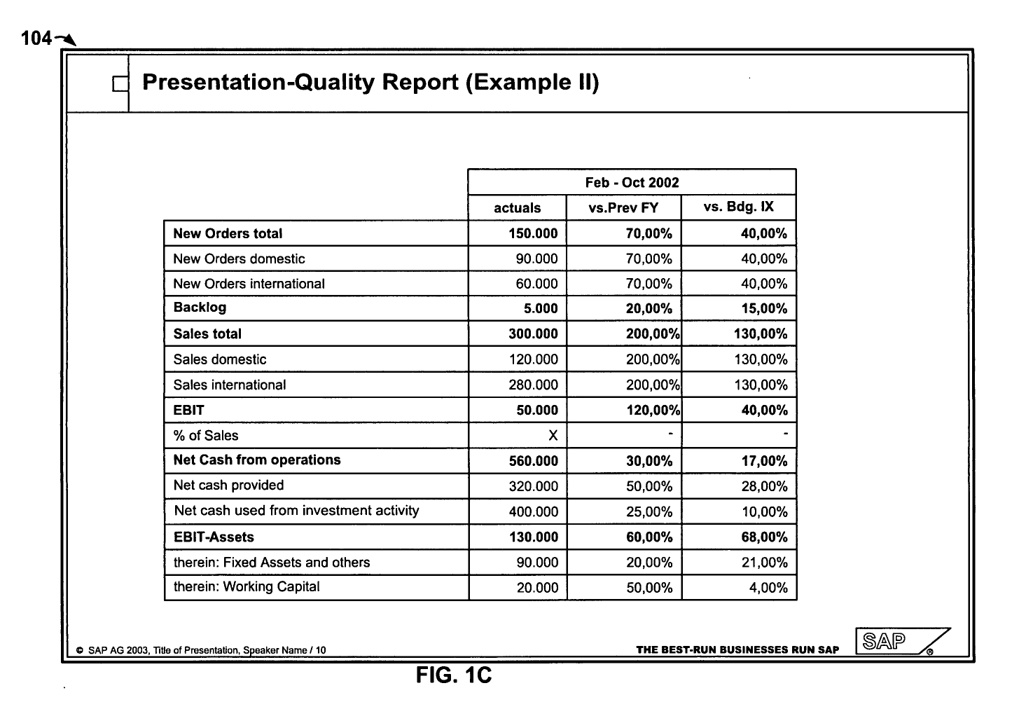

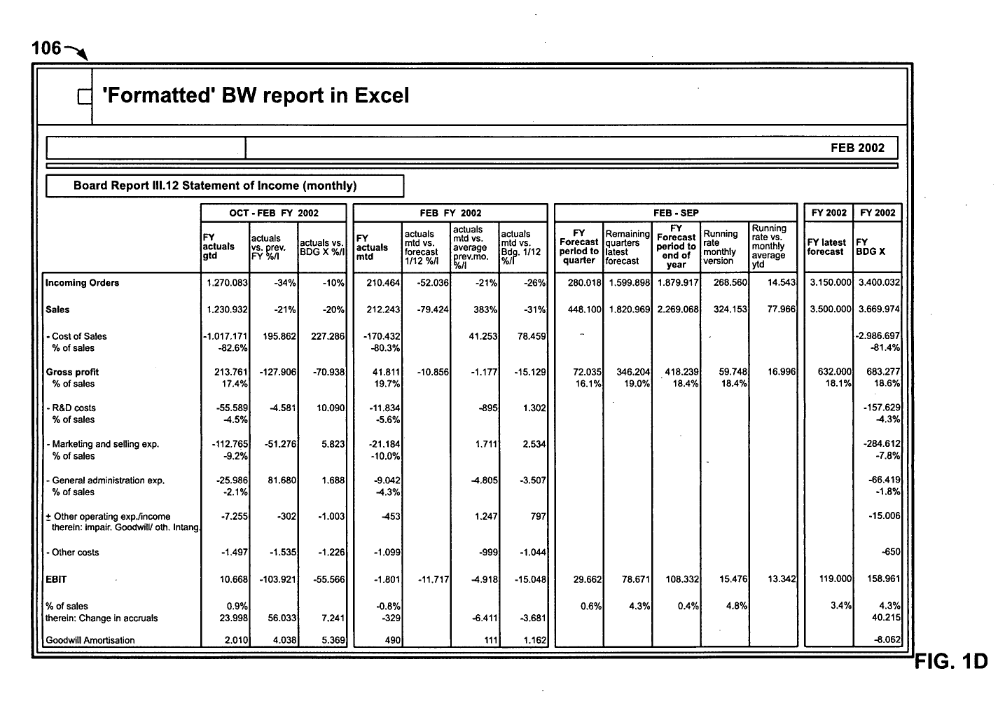

FIG. 1A shows an example of a report 100. The report 100 includes a number of rows and a number of columns, where each intersection of a row and column is a cell. Each cell includes a data object. The data object includes data that can be a number, text, or other information, such as symbols, graphics, etc. One or more rows of the report 100 can represent a row type. For instance, the top row of the report 100 includes column headers, the second row and third rows of the report 100 include a result related to one or more of the column headers, the fourth through ninth rows include information and represent dimension members, and the last row includes information that represents detail or result data. As will be discussed, each of these rows or row groups can represent a group level, for formatting in a drilldown fashion.

Each row type is assigned a row pattern. The pattern can include, without limitation, formatting of color and font, row height and width, merging or splitting of cells, background graphical pattern, etc. The pattern can stored as a template for each row type. During runtime of a BW query, the template or row pattern is assigned to the query data associated with a report being generated. Accordingly, a report can be configured based on row types, and query data is automatically formatted according to the one or more templates to generate the customized report. In one implementation, row types can be identified with a report having a header row, at least one result row, one or more data rows, and at least one characteristic to represent the dimensions. The row types can be identified with logic in the business warehouse data to indicate the type. For example, the business warehouse data may indicate the type of row for the row pattern. The logic in the business warehouse may also enable the report to be generated in Portable Document Format (PDF), a file format developed by Adobe Systems.

When printing the report, the user can choose whether or not to print a header on each page, choose to print out certain sections of the report, and choose to put page breaks within various sections of the report.

FIGS. 1B and 1C illustrate various alternative examples of a report. FIG. 1B shows a report 102 where dimension member rows can be configured to alternate shading from one row to the next, and where detail or result rows are interspersed within the dimension member rows. FIG. 1C shows another example row 104 in which rows are configurable for variable widths based on a column. The system and method for designing a report also supports various hierarchies and structures of BW queries. FIG. 1D shows a report formatted and rendered as a Microsoft Excel™ spreadsheet.

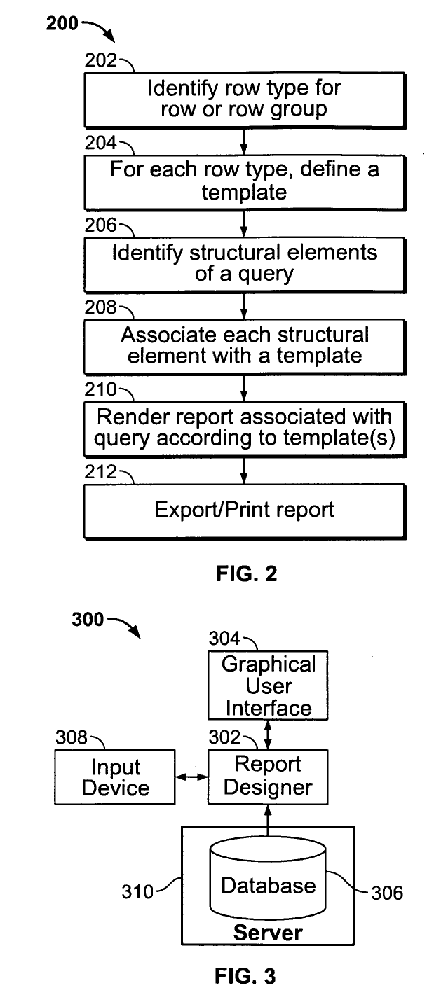

FIG. 2 is a flowchart of a method 200 of designing a report. At 202, a row type is identified for a row or a group of rows. The group of rows can be related to the data object that will be contained in a cell within that or those rows. At 204, for each row type a template is defined. The template represents a pattern that can be selected for the row type. The pattern can include colors, patterning, text type, font type, outline, or other pattern. Group levels are represented by different row patterns that can be formatted separately. The pattern can be grid-based, as opposed to pixel-based, to better accommodate standard report applications.

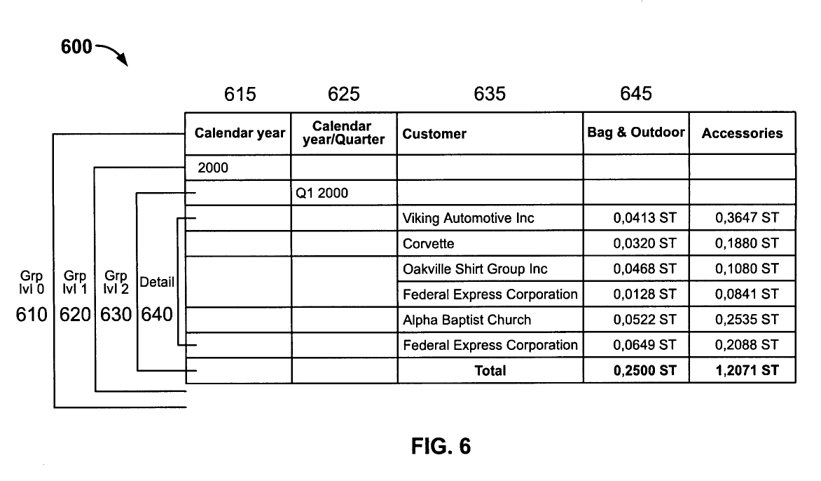

At 206, the structural elements of a BW query are identified. A BW query is generated based on a query of the BW database. The structural elements can be identified according to dimension, structure, or hierarchy, or as combinations of structural elements (dimension x dimension, hierarchy x structure x dimension, etc.). Each structural element in a query row corresponds to a group level, as shown in FIG. 6.

The BW system returns a BW query based on the user query to the database. The report design system extracts data from the BW query to identify its structural elements. For example, objects of the BW query that relate to column header information are identified as column header elements. Query metadata can be used to save data to row patterns to generate an XML representation of the pattern. At 208, each structural element identified in the BW query is associated with a template defined at 204. At 210, a report associated with the BW query is rendered according to the one or more templates. The report may be run in a web-based application and exported to a web page. When the report is rendered, the patterns from 204 are applied to data from the BW server. At 212, the rendered report can be exported to another program such as an application program, or printed.

FIG. 3 illustrates a system 300 for designing reports from business warehouse queries. The system includes a report designer 302. The report designer 302 can be a computer software program implemented as an application, either web-based for delivery to a client computer, or stored locally to the client computer. The report designer 302 generates a rendering of one or more reports on a graphical user interface (GUI) 304. The GUI 304 can also be used to display a designer tool used to configure the reports. The designer tool is preferably implemented as a software program running on a client computer and responsive to command from an input device 308. The input device 308 may be connected directly to the client computer or may communicate through a wireless interface.

The report designer 302 applies templates to data extracted from a BW database 306 and served to the client computer by server 310. As discussed above, the templates define the user-selectable formatting and layout of the report based on identified rows or row groups. The rendered report may be web-based or based on an application such as Microsoft Excel. The report designer 302 can be used to define rules for the data objects to be rendered in the report, i.e. if a characteristic value=“France” then apply a particular format. Specific and/or global formats can be applied via “drag and drop” functions for ease of use and simplicity, and greatly increasing the efficiency of the report designer 302.

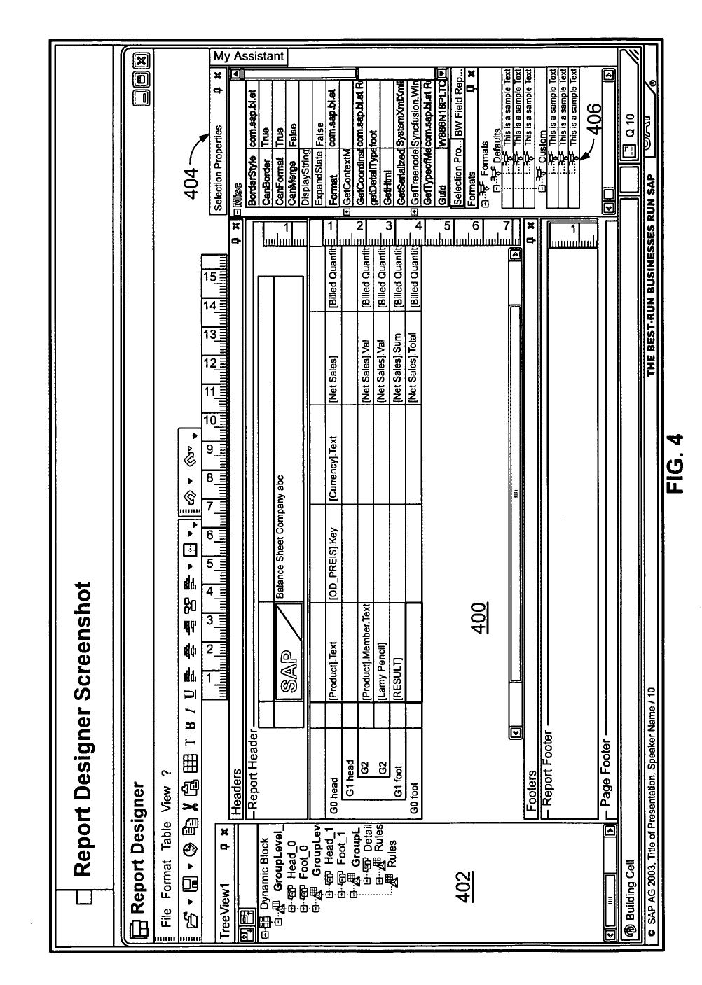

FIG. 4 shows an exemplary screen shot of a report designer. The report designer includes a report template 400 that is configurable by a user to define the formatting and layout of a report. The report designer includes a tree 402 listing all group level objects of a BW query, and a properties box 404 for selection of properties of the report rendering. The properties in the properties box 404 may be applied to the report template by a “drag and drop” function. The report designer further includes a format box 406 representing the various formatting objects that can be applied to individual cells or rows of a report. The formatting objects can also be applied to the report template using a “drag and drop” function. In one implementation, the report designer includes a field repository to recover data in fields that have been deleted.

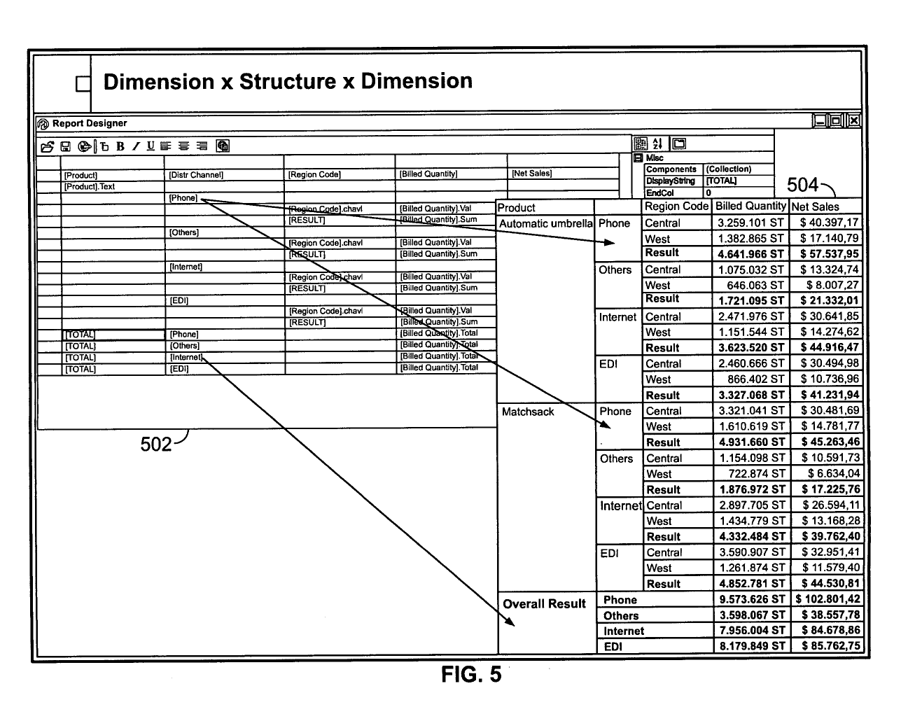

FIG. 5 shows a report template 502 and the resulting report 504 that is generated. Using a system or method described herein, a user can configure a BW query according to predefined templates to generate a report that can be printed, exported, and/or more easily interpreted.

FIG. 6 illustrates group levels and corresponding query structural elements in which data fields may be organized in groups for one or more categories. The user can drill down to various levels of detail in the report. For example, the user may want to view items that are grouped into a calendar year 615 in one group level 610, and then drill down into another group level 620 to view a sales quarter 625 within that calendar year 615. The user may also drill down another group level 630 for customer data 635 to further list details 640 for those customers.

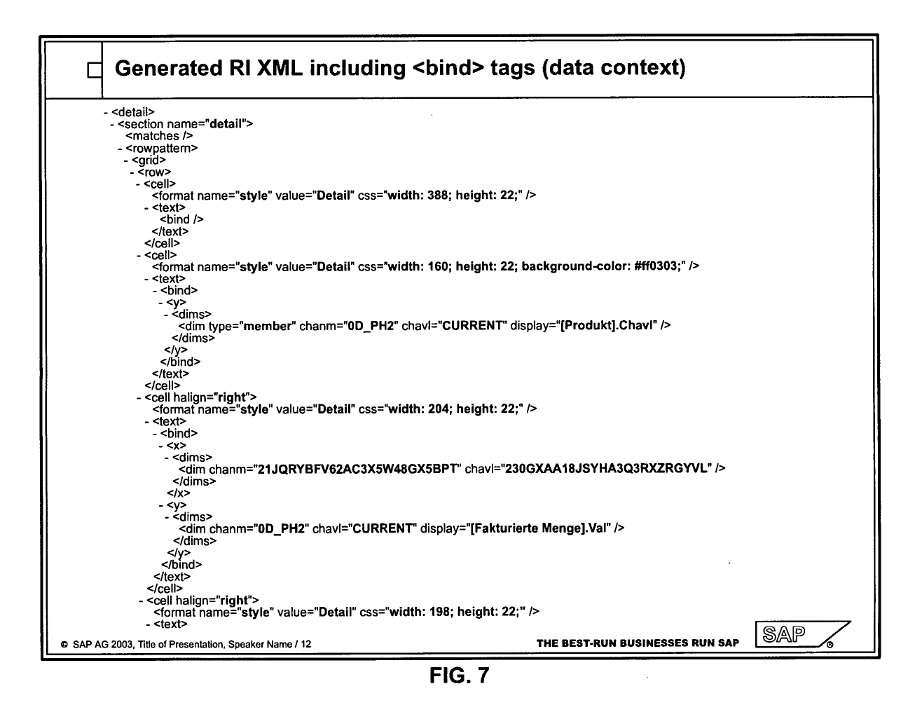

FIG. 7 shows XML code including <bind> tags and data context. The XML code represents a report template encoding scheme for rendering a report with a report designer tool. The designer tool can integrate the data content into the rendered BW report. The data content may include logic to facilitate the integration process. A rendering engine may generate the report in a particular format, such as a web page and/or in PDF.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few embodiments have been described in detail above, other modifications are possible. The logic flow depicted in FIG. 2 does not require the particular order shown, or sequential order, to achieve desirable results. Other embodiments may be within the scope of the following claims.

1. A computer-implemented method for generating a report of a business warehouse system query, the method comprising:
identifying one or more row types of the query;
for each row type, defining a template, wherein the template defines a format and a pattern for the row type; and
applying the template to query data according to the row type to generate a formatted report.

2. The method in accordance with claim 1, wherein the pattern comprises any of a color, a text type, a font type, and an outline.

3. The method in accordance with claim 2, wherein the pattern comprises a grid-based pattern.

4. The method in accordance with claim 1, further comprising identifying one or more structural elements of the query, wherein the one or more structural elements comprise a dimension, a structure, and a hierarchy.

5. The method in accordance with claim 4, further comprising identifying combinations of structural elements, wherein the combinations of structural elements comprise any of a dimension x dimension and a hierarchy x structure x dimension.

6. The method in accordance with claim 5, wherein the identifying of one or more structural elements of the query comprises extracting data from the query.

7. The method in accordance with claim 6, further comprising:
associating the one or more structural elements of the query with the template; and
generating the formatted report according to the template.

8. The method in accordance with claim 7, further comprising:
rendering the formatted report in a display; and
exporting the formatted report.

9. A system for generating a report of a business warehouse system query, comprising:
a database to store business warehouse data;
a report designer program, responsive to user input from an input device, to configure a template of a report based on one or more row types in the query; and
a display coupled to the report designer program, configured to display a report formatted according to the template.

10. The system in accordance with claim 9, wherein the report designer program is configured to be delivered from a website, wherein the report designer program is further configured to be stored on a client computer.

11. The system in accordance with claim 10, wherein the report designer program is operable to use a graphical user interface to generate one or more reports.

12. The system in accordance with claim 11, wherein the template is configured to define user-selectable formatting and layout of the report based on one or more rows.

13. The system in accordance with claim 12, wherein the report designer program is configured to define rules for one or more data objects in the report.

14. The system in accordance with claim 12, wherein the report designer program comprises one or more “drag and drop” functions for one or more formats to be applied to the template.

15. The system in accordance with claim 14, wherein the one or more “drag and drop” functions comprise any of a property box to select properties of a report rendering and a format box to represent one or more formatting objects to be applied to individual cells or rows of the report.

16. The system in accordance with claim 12, wherein the report designer program comprises XML code to represent a report template encoding scheme for rendering the report.

17. A computer program product, stored on a machine-readable medium, the computer program product comprising instructions operable to cause data processing apparatus to:
design a report of a business warehouse query comprising:
identify a row type for a row or a row group in the report;
define a row pattern template for each row type;
identify one or more structural elements of the query, wherein the one or more structural elements comprise a dimension, a structure, and a hierarchy;
associate a structural template for each of the one or more structural elements; and
render a report associated with the query according to one or more templates, wherein the one or more templates comprise any of the row pattern template and the structural template.

18. The computer program product in accordance with claim 17, wherein the design of the report further comprises exporting the rendered report.

19. The computer program product in accordance with claim 17, wherein the row pattern template is defined at runtime.

20. The computer program product in accordance with claim 20, wherein the report is designed based on the row type.
